(19) United States
(12) Patent Application Publication
(10) Pub. No.: US 2022/0010760 A1
(43) Pub. Date: Jan. 13, 2022

(54) FUEL INJECTION DEVICE

(71) Applicant: ZAMA JAPAN CO. LTD., Iwate (JP)

(72) Inventors: Chizuru Ogasawara, Iwate (JP); Issei Fumoto, Iwate (JP); Yuki Miura, Iwate (JP); Kasumi Ito, Iwate (JP); Ko Oiguchi, Iwate (JP)

(21) Appl. No.: 17/371,854

(22) Filed: Jul. 9, 2021

(30) Foreign Application Priority Data
Jul. 9, 2020 (JP) 2020-118222

(51) Int. Cl. F02M 69/16; F02M 69/02; F02M 59/46

(52) U.S. Cl. CPC F02M 69/16; F02M 59/46; F02M 69/02

(57) ABSTRACT

A fuel supplying device is provided with a supplemental fuel chamber such that there is no delay in the supply of fuel during high-speed operation. The fuel supplying device comprises: an outlet pipe in communication with a fuel injecting nozzle equipped in an intake manifold of an engine or an air intake passage of a carburetor; a pressing member configured to undergo reciprocating motion synchronized with the rotational period of an engine; a fuel chamber configure to supply fuel to an intake manifold of the engine from the fuel injecting nozzle through cooperation of the reciprocating motion of the pressing member, wherein the inlet check valve and the outlet check valve are configured to open and close alternatingly; and a fuel reservoir having a prescribed volume is connected and disposed upstream of the inlet check valve in the inlet pipe.

### CROSS-REFERENCE TO RELATED APPLICATION

The subject application claims the benefit of Japanese Patent Application No. 2020-118222, filed Jul. 9, 2020, which application is incorporated herein by reference in its entirety.

### TECHNICAL FIELD

The disclosure relates generally to the field of fuel injection devices. Specifically, and not by way of limitation, the disclosure relates to a high-speed fuel injection devices.

### BACKGROUND

Conventionally, fuel supplying devices are equipped with an inlet that is in fluid communication with a fuel chamber through an inlet check valve, and an outlet pipe that is in fluid communication with a fuel injecting nozzle, which is provided in an intake manifold of an engine or an air intake passage of a carburetor, through an outlet check valve in a pump chamber of a fuel pump. The pump chamber of the fuel pump includes a pressing member, such as a diaphragm or a plunger, that undergoes a reciprocating motion synchronized with the rotational period of the engine. Fuel that is stored in the fuel chamber is supplied to the intake manifold of the engine or the air intake passage of the carburetor via the fuel injecting nozzle due to the reciprocating motion of the pressing member in the fuel pump as the inlet and outlet check valves open and close alternatingly. These arrangements are generally known through, for example, Japanese Unexamined Patent Application Publication S56-151260, Japanese Unexamined Patent Application Publication 2000-145572, Publication 2011-43087, and the like. This type of fuel supplying device, given its simplicity, has long been popular in general-use engines and small engines that have relatively simple structures.

In fuel supplying devices that use a reciprocating pump motion, the diaphragm undergoes a reciprocating motion caused by the pulsation of air from the engine intake manifold or by the rotational mechanical force of the engine cam. When the engine is running rapidly, the reciprocating motion of the diaphragm cannot keep up with the rotation of the engine. This causes a delay in the supply of fuel causing a lean fuel-air mixture, which may cause failures in engine acceleration. In the most typical stationary Venturi-type carburetor, the effect is large, due to the fuel being drawn into the air intake duct through the negative pressure of the Venturi effect. As a result, conventional methods have been provided, for example, Japanese unexamined Patent Application Publication 2007-71054 and Japanese unexamined Patent Application Publication 2000-249013, and the like, that include various types of fuel increasing means such as using secondary pumps and dampers. The secondary pump can increase the amount of fuel when the engine speed is high. The dampers can eliminate pulsation by adding it to the outlet pipe. These fuel increasing means are driven when the engine is running at a high speed to increase the fuel flow rate that is inadequate when running these high speeds. However, these fuel increasing means require extra components and thus increase the size of the engine, which complicates manufacturing and increases costs.

While diaphragm-type pump is well suited to small general-use engines, adjustments have been made to address the negative pressure within the fuel chamber. In one adjustment, a damper is provided that is positioned further toward the upstream side of the inlet pipe than the inlet check valve. The damper includes an air chamber facing the fuel chamber with a diaphragm therebetween. However, such damper causes the diaphragm structure to be complex and the size of the fuel pump to be larger. This makes the solution difficult to use in a small general-use engine.

### SUMMARY

One of the objectives of the present disclosure is to provide a high-speed fuel supplying device designed and made to provide a consistent fuel mixture during high-speed and high acceleration while also being small enough for use in small general-use engines.

In some embodiments, the fuel supplying device includes an outlet pipe that is in communication with a fuel injecting nozzle located in an intake manifold of an engine or in an air intake passage of a carburetor through an outlet and inlet check valves. The fuel supplying device includes a pressing member configured to have reciprocating motion synchronized with the rotational period of an engine. Fuel in the fuel chamber is supplied to the intake manifold of the engine (or the air intake passage of the carburetor) from the fuel injecting nozzle through cooperation of the reciprocating motion of the pressing member in the fuel pump and the inlet check valve and the outlet check valve that open and close alternatingly. A fuel reservoir of a prescribed volume is connected and disposed upstream of the inlet check valve of inlet pipe.

The fuel reservoir can have a closed-bottom cylindrical body, which can be easily mass produced, and the total volume of the reservoir can also be easily changed.

Moreover, in the present fuel supplying device, there is no need to provide a damper having an air chamber that faces the fuel chamber and a diaphragm therebetween. Additionally, as has been conventional when the fuel pump is a diaphragm-type pump that uses a diaphragm as the pressing member, the supplemental fuel chamber is disposed in the upstream side of the inlet check valve in the inlet pipe, making it possible to achieve a smaller form overall.

The fuel supplying device according to the present disclosure is well-suited for high-speed operation of small general-use engines. Engines having the improved fuel supplying device will have no acceleration failures due to lean fuel mixture caused by a delay in the supply of fuel when the engine is running at a high speed.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates a perspective view of a fuel supplying device in accordance with some embodiments of the present disclosure.

FIG. 2 illustrates a cross-sectional view of the fuel supplying device of FIG. 1 along section line A-A in accordance with some embodiments of the present disclosure.

FIG. 3 illustrates a cross-sectional view of the fuel supplying device of FIG. 1 along section line B-B in accordance with some embodiments of the present disclosure.

FIG. 4 illustrates a cross-sectional view of the fuel supplying device of FIG. 1 along section line C-C in accordance with some embodiments of the present disclosure.

FIG. 5 is a graph illustrating the fuel flow rate vs engine speed of a conventional fuel supplying device and the fuel supplying device of FIG. 1.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

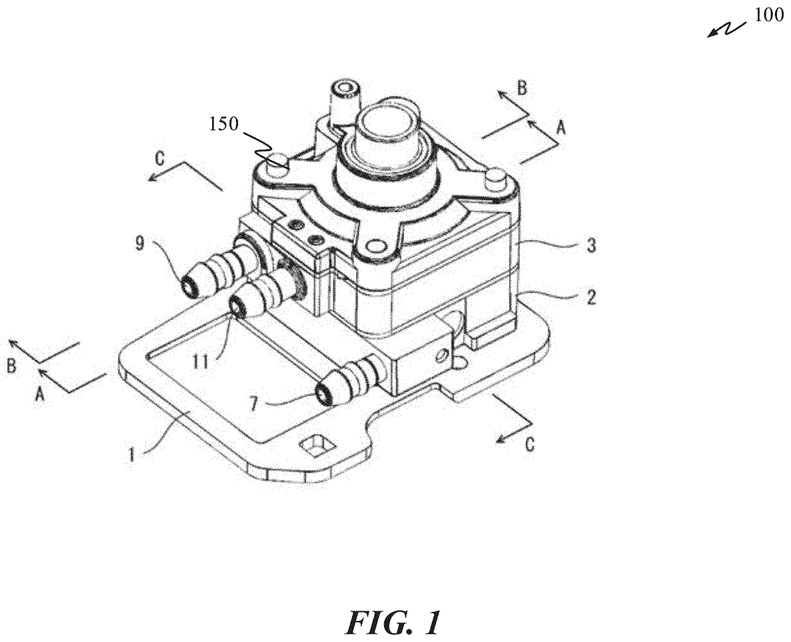

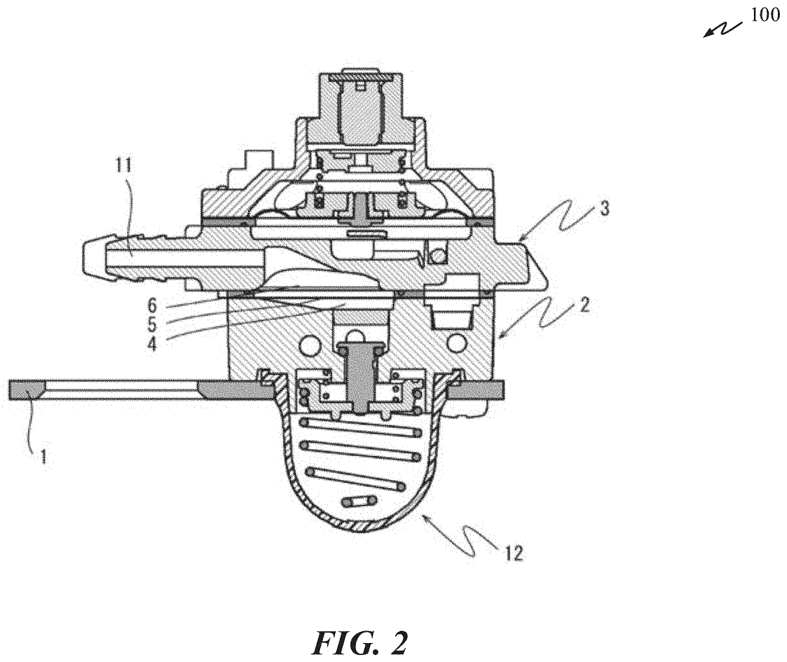

FIGS. 1 through 4 illustrate a fuel supplying system 100 in accordance with some embodiments of the present disclosure. FIG. 1 illustrates a perspective view of fuel supplying system 100. System 100 includes a fuel injecting nozzle disposed within an intake manifold. Fuel in a fuel chamber is injected by the reciprocating motion of a diaphragm, which is caused by pulses (air pulsation) from a crank chamber or an intake manifold of an engine. In some embodiments, a diaphragm-type pump 150 of system 100 includes a diaphragm (e.g., a pressing member) configured to provide an increased amount of fuel in the high-speed domain. Diaphragm-type pump 150 includes a first outer body 2 and a second outer body 3. Each outer body can have a square, circular, rectangular, or any polygonal shape. In some embodiments, both bodies 2 and 3 have a square-shaped body. Bodies 2 and 3 can be attached together to form a hollow pump chamber 4 (FIG. 2). Body 2 can be attached to a substrate 1 for securing pump 150 to the engine, the carburetor, or the like.

FIG. 2 illustrates a cross-sectional view of fuel supplying system 100 along section line A-A. As shown, pump chamber 4 is formed by outer bodies 2 and 3. Pump chamber 4 can span into both of bodies 2 and 3. Alternatively, pump chamber 4 can be disposed in outer body 2 only. At the junction portion of outer bodies 2 and 3, a pulse chamber 6 for causing reciprocating motion of a pressing member (e.g., diaphragm) 5 through pulses (air pulsation) from the engine is formed. Pump chamber 4 is an airtight chamber formed by outer bodies 2 and 3. Pressing member 5 is configured to undergo reciprocating motion in the axial direction, with the diaphragm arranged in the horizontal direction. Pressing member 5 can be positioned between pump chamber 4 and pulse chamber 6.

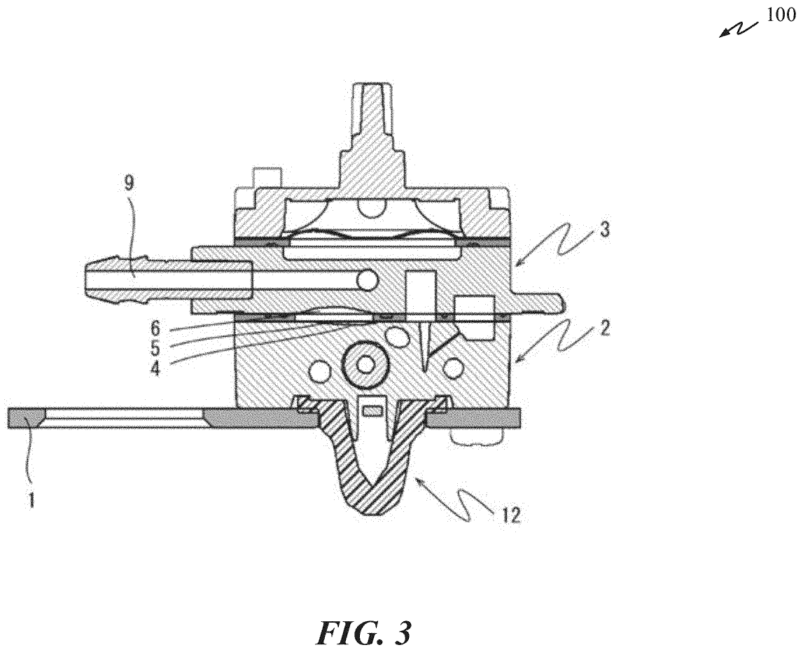

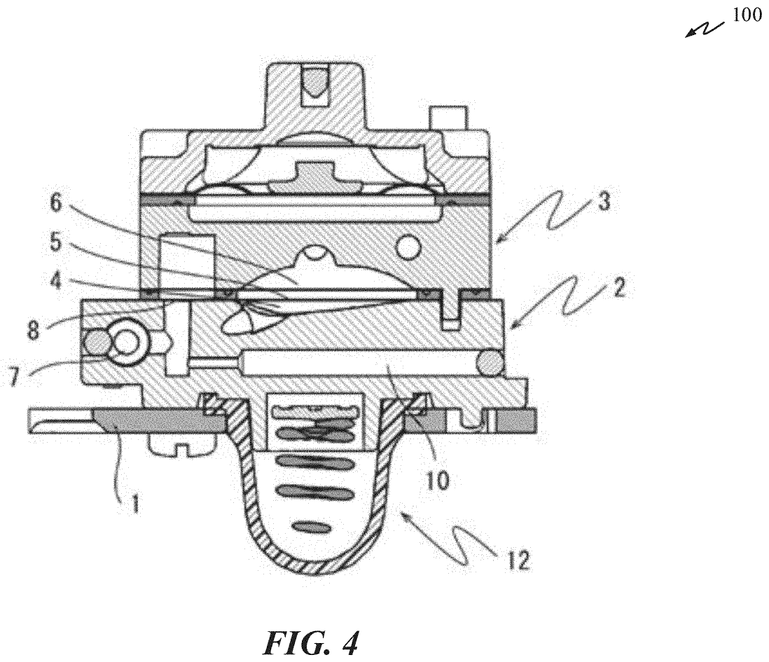

In some embodiments, an inlet pipe 7 (FIG. 4) includes a connecting portion (not shown) that connects, at the tip end, to the fuel chamber (not shown). The fuel chamber is disposed on outer body 2 wherein it is connected to pump chamber 4 through inlet check valve 8 (FIG. 4). Outlet pipe 9 (FIG. 3) has a connecting portion connected to a fuel injecting nozzle that is provided, at the tip end, in an air intake passage of the carburetor.

The air intake passage is disposed on the case body 3 in a state that is connected to the pump chamber 4 through an outlet check valve (not shown). In some embodiments, fuel reservoir 10 (or supplemental fuel reservoir) can be a closed-bottom cylindrical body having a prescribed volume. Fuel reservoir 10 is connected and disposed at a position upstream of the inlet check valve 8 in the inlet pipe 7.

Referring to FIG. 2, pulse connecting tube 11 is configured to direct pulses (air pulsation) from the engine into the pulse chamber 6. Primary pump 12 is in communication, in an airtight state, with the pump chamber 4 through the attaching substrate and the bottom wall (not shown) of the case body 2.

When the engine speed is high in a conventional fuel supplying device, the reciprocating motion of a conventional pressing member is unable to keep up with the rotation of the engine. This delays the fuel supply and causes the fuel mixture to be lean and thereby resulting in engine acceleration failures. In contrast, with the improved fuel supplying device 100 of the present disclosure, the engine can be started in a state wherein pump chamber 4 is filled with fuel through the inlet check valve 8 from the inlet pipe 7, which is connected to the inlet hose (not shown). Through the manual operation of primary pump 12, the air pulsation from the engine is introduced into the pulse chamber 6 via pulse connecting tube 1. The pulsation of the air can cause pressing member 5 to undergo reciprocating motion. The amount of fuel necessary for high-speed operation is supplied by storing the fuel in advance in fuel reservoir 10, which acts as a supplementary fuel pump chamber.

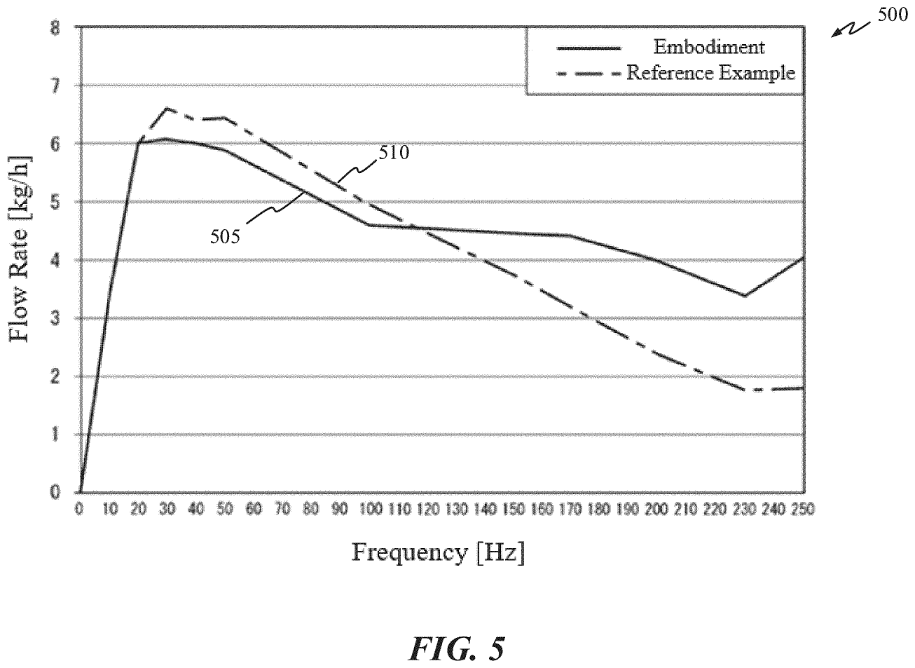

FIG. 5 illustrates the fuel flow rate vs engine speed (in frequency). Line 505 (solid) represents the flow rate vs frequency of fuel supplying system 100. As shown, the fuel rate of flow remains high all the way to 250 Hz (high-speed domain). In contrast, line 510 (dotted) represents the flow rate vs frequency of a conventional engine. As shown, the fuel flow rate drops dramatically (as indicated by line 510) when the engine speed is above 120 Hz as compared to the flow rate of fuel supplying system 100.

The graph shows essentially identical results for both in the mid-speed domain from startup up to a frequency of 120 Hz. However, in the high-speed domain of between 120 and 250 Hz, the flow rate of fuel supplying system 100 is reliably greater than the fuel flow rate of conventional engines.

As demonstrated by the data of FIG. 5, the fuel flow rate remains high (little to no delay) even when the speed of the engine is in the high-speed domain. This eliminated the issue of engine acceleration failure caused by a lean fuel mixture. Additionally, fuel reservoir 10 of fuel supplying system 100 is shaped compactly with simple structure. This makes it possible for fuel supplying system 100 to be inexpensive and well suited for a small general-use engine.

In particular, fuel supplying system 100 enables fuel to be supplied at a steady rate without delay during high-speed operation and without an adverse effect in the mid-speed domain because there is no accumulated fuel flow past inlet check valve 8 into pump chamber 4 prior to the mid-speed domain. Fuel reservoir 10 is connected and located at a position that is upstream of the inlet check valve 8 in the inlet pipe 7.

Moreover, while fuel supplying system 100 can include a closed-bottom cylindrical fuel reservoir 10 disposed in a horizontal state in a gap formed with the case body 2, fuel reservoir 10 may instead be disposed facing in a vertical direction. In some embodiments, fuel reservoir 10 can be located in inlet pipe 7 and protrudes to the outside of the case body 2. For instance, fuel reservoir 10 can be partially or fully located outside of outer body 2 and can be configured to attach easily to outer body 2. In some embodiments, fuel reservoir 10 can be retrofitted onto existing fuel supplying devices. Additionally, fuel reservoir 10 can be fluidically connected to inlet pipe 7 and can extend to the outside of outer body 2.

Note that while fuel supplying device 100 can use a diaphragm-type fuel pump to inject fuel in a fuel injecting nozzle that is disposed in the intake manifold of an engine, fuel supplying system 100 can also have a plunger-type pressing member. Additionally, while fuel supplying system 100 can use a mechanical fuel injecting device as illustrated, fuel supplying system 100 can also be executed using a well-known electronically controlled fuel supplying system.

Moreover, while in the present embodiment the depiction was for a fuel supplying device that is used in the case of a fuel supplying system of a type wherein pressurized fuel is sprayed in a fuel injecting nozzle that is disposed in an intake manifold of an engine, the present invention can also be applied in a fuel pump of another type, such as a typical stationary or variable Venturi-type carburetor, or the like.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A fuel supplying device comprising:
an outlet pipe coupled to a fuel injecting nozzle through an outlet check valve and an inlet pipe, wherein the inlet pipe is coupled to a fuel chamber through an inlet check valve and to a pump chamber of a fuel pump;
a pressing member configured to undergo reciprocating motion synchronized with rotational period of an engine;
a fuel chamber configure to supply fuel to an intake manifold of the engine from the fuel injecting nozzle through cooperation of the reciprocating motion of the pressing member, wherein the inlet check valve and the outlet check valve are configured to open and close alternatingly; and
a fuel reservoir having a prescribed volume is connected and disposed upstream of the inlet check valve in the inlet pipe.

2. The fuel supplying device of claim 1, the fuel reservoir comprises a closed-bottom cylindrical body.

3. The fuel supplying device of claim 2, wherein the fuel reservoir is disposed parallel to the fuel chamber.

4. The fuel supplying device of claim 2, wherein the fuel reservoir is disposed perpendicular to the fuel chamber.

5. The fuel supplying device of claim 2, wherein a portion of the fuel reservoir protrude outside a body of the fuel supplying device.

6. The fuel supplying device of claim 1, wherein the fuel pump comprises a diaphragm-type pump that uses a diaphragm as the pressing member.

7. A fuel supplying device comprising:
a first outer body having an outlet pipe, a pulse pipe, and a pulse chamber, where the pulse pipe is configured to provide pulsation air to the pulse chamber;
a second outer body comprising:
an inlet pipe having an inlet check valve;
a supplemental fuel reservoir in fluid communication with the inlet pipe; and
a pump chamber;
a pressing member disposed at a junction of the first and second outer bodies, the pressing member is configured to undergo reciprocating motion synchronized with rotational period of an engine;

8. The fuel supplying device of claim 7, wherein the supplemental fuel reservoir is connected and disposed upstream of the inlet check valve in the inlet pipe.

9. The fuel supplying device of claim 7, the supplemental fuel reservoir comprises a closed-bottom cylindrical body.

10. The fuel supplying device of claim 7, wherein the supplemental fuel reservoir is disposed parallel to the pump chamber.

11. The fuel supplying device of claim 7, wherein the supplemental fuel reservoir is disposed perpendicular to the pump chamber.

12. The fuel supplying device of claim 7, wherein a portion of the supplemental fuel reservoir protrudes outside a body of the fuel supplying device.

13. The fuel supplying device of claim 7, wherein pressing member comprises a diaphragm-type pump.
